(19) United States
(12) Patent Application Publication
(10) Pub. No.: US 2010/0128333 A1
(43) Pub. Date: May 27, 2010

(54) HOLOGRAM RECORDING AND REPRODUCING SYSTEM

(75) Inventor: Makoto Sato, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/089,354

(22) PCT Filed: Sep. 29, 2006
(86) PCT No.: PCT/JP2006/320036

§ 371 Date: Jun. 30, 2008

(30) Foreign Application Priority Data
Oct. 5, 2005 (JP) 2005-292819

(51) Int. Cl. G03H 1/02

(52) U.S. Cl. 359/3; 359/30

(57) ABSTRACT

A hologram recording and reproducing system for recording information to or reproducing information from a recording medium which stores an optical interference pattern of a reference beam and a signal beam as a diffraction grating, the system comprising: a light source for generating a coherent beam; and a light generation section which is disposed on an optical axis, has a signal beam region and a reference beam region that are in a rotary inversion with respect to the optical axis in a cross-section of the coherent beam, and spatially splits the coherent beam into a signal beam and a reference beam which propagate in the signal beam region and the reference beam region respectively; a light interference section which is disposed on the optical axis, has a signal beam region and a reference beam region that are in a rotary inversion with respect to the optical axis, corresponding to the signal beam region and the reference beam region to transmit the reference beam and the signal beam respectively, and condenses the reference beam and the signal beam at different focal points on the optical axis so as to allow the reference beam and signal beam to interfere; a recording medium comprising a hologram recording layer at least positioned between the different focal points; and image detection means which is disposed on the optical axis and receives light returning from the hologram recording layer when the reference beam is irradiated on the hologram recording layer via an objective lens optical system.

### TECHNICAL FIELD

The present invention relates to a recording medium for optically recording or reproducing information, such as an optical disk and optical card, and more particularly to a hologram recording and reproducing system of a recording medium which has a hologram recording layer where information can be recorded or reproduced by irradiating a beam.

### BACKGROUND ART

Holograms which can record two-dimensional data at high density is receiving attention for high density information recording. The feature of a hologram is recording the wave surface of a signal beam holding recording information on a recording medium made of photosensitive material, such as photo-refractive material, as interference fringes with a reference beam, that is, according to the volumetric changes of the refractive index. By performing holographic multiple recording, such as multiplexing angles, on a recording medium, recording capacity can be increased. As a structure of the recording medium, a recording medium in which a substrate, reflection layer and hologram recording layer are formed in this sequence is known.

Generally, when a hologram is recorded by crossing a reference beam and signal beam, the angle selectability of the hologram improves as the mixing angle (smaller one of the angles formed by two beams, regarding the angle when the propagation directions of the beams match as 0 degrees) increases, and more holograms can be multiplexed and recorded in a same location on the hologram recording layer. In other words, in order to record information at high density, an interference form of a hologram, which makes the mixing angle larger, is desirable.

For example, as shown in FIG. 2, a technology of inserting a special light modulator, of which left half is a signal beam and right half is a reference beam (transmission), as shown in FIG. 1, into an optical path and recording a hologram by interference of the left and right beams, is known (see Japanese Patent Application Laid-Open KOKAI No. Hei 11-237829).

In the case of a reflection type hologram recording system where one region is for a reference beam, and the other area for a signal beam, as in the above mentioned prior art, if the condensing positions of the two beams are the same on the reflection layer, then the signal beam and reference beam cross facing each other (both are spherical waves which condense at one point), as shown in FIG. 3. In other words, the mixing angle is 0 degrees, which is not suitable for high density recording. Since the focal positions of the signal beam and the reference beam are the same in this configuration, a mixing angle cannot be generated, hence angle selectability is poor, which is not appropriate for high density information recording.

Another prior art for shifting the focal positions of the signal beam and the reference beam is converging the signal beam on the reflection layer and defocusing the reference beam for recording on the reflection layer in the optical recording system, and irradiating the reference beam for recording so as to converge at a point beyond the reflection layer, as shown in FIG. 4 (see Japanese Patent Application Laid-Open KOKAI No. 2004-171611).

### DISCLOSURE OF THE INVENTION

In the latter prior art, the diffusion and convergence of the reference beam and the signal beam may differ between the beam entering the objective lens and the beam which is reflected and returned from then objective lens. The signal beam, of which condensing position is on the reflection layer, enters the objective lens as a collimated light, and the reflected light of the signal beam also returns as a collimated light. The reference beam, however, enters the object lens as diffused light and becomes a converged light after the reflection layer, but because of the reflection layer, the reference beam is condensed at a position near the objective lens. This means that the condensing position of the reference beam is a point which is shorter than the focal distance of the objective lens, so the reflected light of the reference beam, which passes through the objective lens and returns, becomes a light which diffuses from the objective lens. In this way, the lights which enter and leave the objective lens become a mixture of lights in various diffusion states, such as collimated light, light diffusing toward the objective lens, and diffused light returned from the objective lens.

Therefore the latter prior art has a shortcoming, that is, the optical system from the light source to the objective lens becomes complicated. The return light of the reference beam, which is not directly related to recording and reproducing, can be left alone without providing a special optical system, but in this case, this return light which becomes stray light may possibly interfere with the original signals, which is not desirable. In the latter prior art, a structure to change the focal positions of the reference beam and the signal beam exists in the incoming optical paths, but the optical paths of the reflected light of the reference beam are unknown, so this reflected light of the reference beam definitely becomes stray light. Also many optical components are required to generate and converge the reference beam and the signal beam, which diminish downsizing of the device.

With the foregoing in view, it is an object of the present invention to provide a hologram recording and reproducing method and a hologram device which allows stable recording or reproduction in a hologram recording and reproducing system for recording information to or reproducing information from a recording medium which stores optical interference patterns of a reference beam and a signal beam as diffraction grating.

A hologram recording and reproducing system according to the present invention is a hologram recording and reproducing system for recording information to or reproducing information from a recording medium which stores an optical interference pattern of a reference beam and a signal beam as diffraction grating, the system comprising: a light source for generating a coherent beam; a light generation section, which is disposed on an optical axis, has a signal beam region and a reference beam region that are in a rotary inversion with respect to the optical axis in a cross-section of the coherent beam, and spatially splits the coherent beam into a signal beam and a reference beam which propagate in the signal beam region and the reference beam region respectively; a light interference section, which is disposed on the optical axis, has a signal beam region and a reference beam region that are in a rotary inversion with respect to the optical axis, corresponding to the signal beam region and the reference beam region to transmit the reference beam and the signal beam respectively, and condenses the reference beam and the signal beam at different focal points on the optical axis so as to allow reference beam and signal beam to interfere; a recording medium comprising a hologram recording layer at least positioned between the different focal points; and image detection means which is disposed on the optical axis, and receives light returning from the hologram recording layer when the reference beam is irradiated on the hologram recording layer via an objective lens optical system.

According to this hologram recording and reproducing system, the reference beam and the signal beam are separated in a rotary inversion around an optical axis, and the focal positions of the reference beam and the signal beam are different from each other, so the signal beam and the reference beam interfere because of the shifted focal positions, and inside the hologram recording layer, beams having mutually different focal points cross, and a large mixing angle state can be secured. The optical path length of the beam, which enters the objective lens, is reflected on the reflection plane and then passes through the objective lens again, and is the same for all the beams which enter any part of the objective lens, so the reflected light of the light which entered the objective lens as collimated light can be returned from the objective lens again as collimated light. Since the diffusion and the convergence state of lights are different between the beam which enters the objective lens and irradiates, and the beam which is reflected and returned from the objective lens, all lights which enter and exit the objective lens can be collimated light even if the focal position is different between the reference beam and the signal beam inside the hologram recording layer, and an optical path from the light source and the objective lens can be constructed by a simple optical system similar to the pickup of a general optical disk. According to this hologram recording and reproducing system, unnecessary stray lights are not generated.

### BRIEF DESCRIPTION OF THE DRAWINGS

FIG. 1 is a front view depicting a spatial light modulator for describing a conventional hologram recording.

FIG. 2 is a partial cross-sectional view depicting an optical system and a recording medium for describing a conventional hologram recording.

FIG. 3 is a partial cross-sectional view depicting a recording medium for describing a conventional hologram recording.

FIG. 4 is a partial cross-sectional view depicting an objective lens and recording medium for describing a conventional hologram recording.

FIG. 5 is a cross-sectional view depicting an optical system and recording medium for describing a recording and reproducing device according to an embodiment of the present invention.

FIG. 6 is a front view depicting a spatial light modulator in the recording and reproducing device viewed from the optical axis according to an embodiment of the present invention.

FIG. 7 is a front view depicting an objective lens module in the recording and reproducing device viewed from the optical axis according to an embodiment of the present invention.

FIG. 8 is a front view depicting a signal beam region and reference beam region in a spatial light modulator or an objective lens module viewed from the optical axis according to another embodiment of the present invention.

FIG. 9 is a front view depicting a signal beam region and reference beam region in a spatial light modulator or an objective lens module viewed from the optical axis according to another embodiment of the present invention.

FIG. 10 is a front view depicting a signal beam region and reference beam region in a spatial light modulator or an objective lens module viewed from the optical axis according to another embodiment of the present invention.

FIG. 11 is a front view depicting a signal beam region and reference beam region in a spatial light modulator or an objective lens module viewed from the optical axis according to another embodiment of the present invention.

FIG. 12 is a front view depicting a signal beam region and reference beam region in a spatial light modulator or an objective lens module viewed from the optical axis according to another embodiment of the present invention.

FIG. 13 is a front view depicting a signal beam region and reference beam region in a spatial light modulator or an objective lens module viewed from the optical axis according to another embodiment of the present invention.

FIG. 14 is a front view depicting a signal beam region and reference beam region in a spatial light modulator or an objective lens module viewed from the optical axis according to another embodiment of the present invention.

FIG. 15 is a front view depicting a signal beam region and reference beam region in a spatial light modulator or an objective lens module viewed from the optical axis according to another embodiment of the present invention.

FIG. 16 is a front view depicting a signal beam region and reference beam region in a spatial light modulator or an objective lens module viewed from the optical axis according to another embodiment of the present invention.

FIG. 17 is a front view depicting a signal beam region and reference beam region in a spatial light modulator or an objective lens module viewed from the optical axis according to another embodiment of the present invention.

FIG. 18 is a front view depicting a signal beam region and reference beam region in a spatial light modulator or an objective lens module viewed from the optical axis according to another embodiment of the present invention.

FIG. 19 is a partial cross-sectional view depicting a recording medium for describing a hologram recording in the recording and reproducing device according to another embodiment of the present invention.

FIG. 20 is a cross-sectional view depicting an optical system and recording medium for describing the recording and reproducing device according to another embodiment of the present invention.

FIG. 21 is a cross-sectional view depicting a configuration example of an entire optical system of the hologram recording and reproducing device according to an embodiment of the present invention.

FIG. 22 is a cross-sectional view depicting a configuration example of an entire optical system of the hologram recording and reproducing device according to an embodiment of the present invention.

FIG. 23 is a cross-sectional view depicting a configuration example of an entire optical system of the hologram recording and reproducing device according to an embodiment of the present invention.

FIG. 24 is a cross-sectional view depicting an optical system and recording medium for describing the recording and reproducing device according to another embodiment of the present invention.

FIG. 25 is a cross-sectional view depicting an optical system and recording medium for describing the recording and reproducing device according to another embodiment of the present invention.

FIG. 26 is a cross-sectional view depicting an optical system and recording medium for describing the recording and reproducing device according to another embodiment of the present invention.

FIG. 27 is a front view depicting an optical lens module in the recording and reproducing device viewed from the optical axis according to another embodiment of the present invention.

FIG. 28 is a cross-sectional view depicting an optical system and recording medium for describing the recording and reproducing device according to another embodiment of the present invention.

FIG. 29 is a cross-sectional view depicting an optical system and recording medium for describing the recording and reproducing device according to another embodiment of the present invention.

FIG. 30 is a front view depicting an objective lens module in the recording and reproducing device viewed from the optical axis according to another embodiment of the present invention.

FIG. 31 is a cross-sectional view depicting an optical system and recording medium for describing the recording and reproducing device according to another embodiment of the present invention.

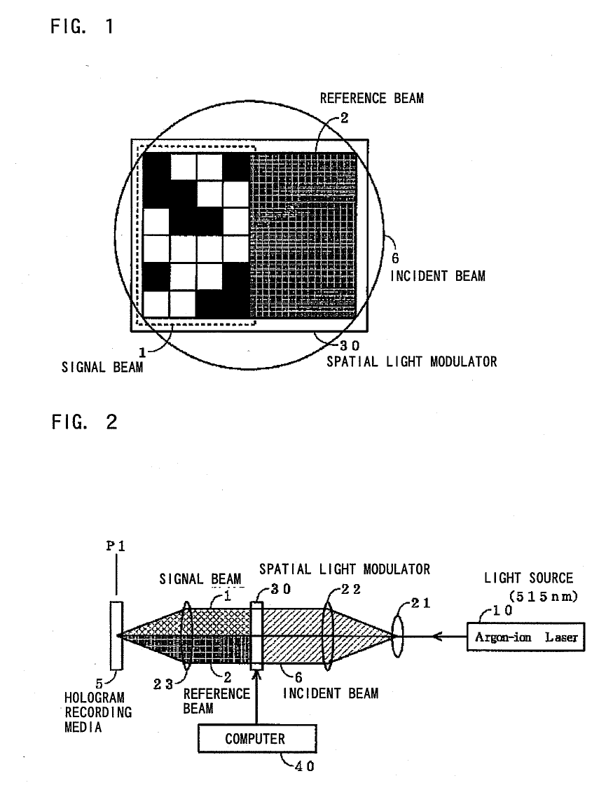

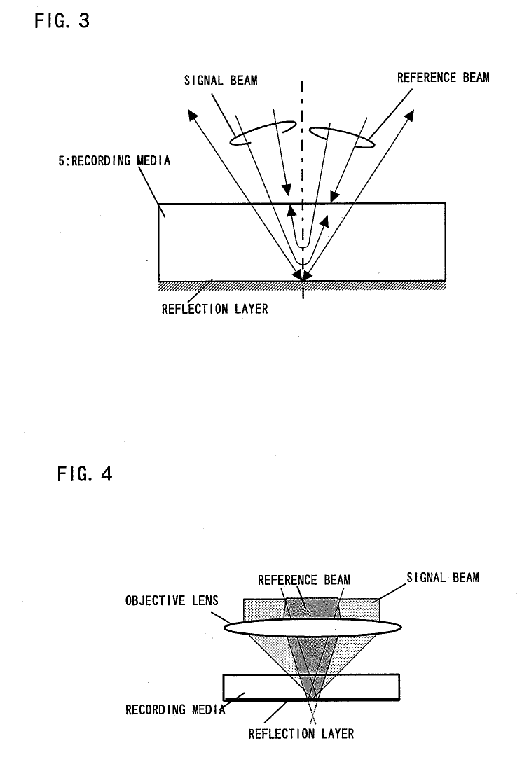

### DETAILED DESCRIPTION OF THE INVENTION

Embodiments of the present invention will now be described with reference to the drawings.

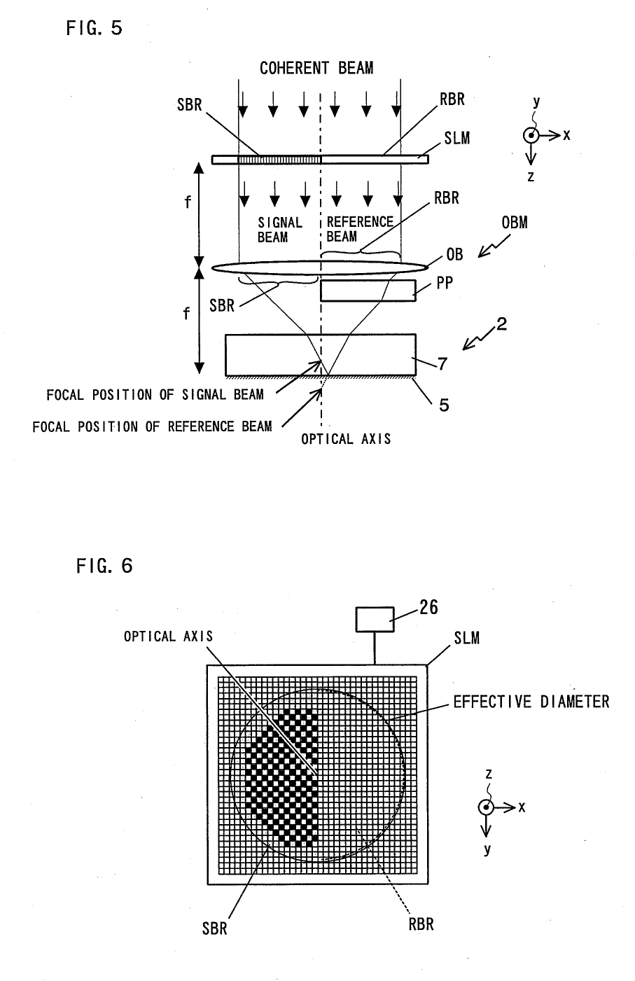

FIG. 5 is a cross sectional view depicting the key sections of an example of a hologram recording and reproducing system.

The hologram recording and reproducing system comprises a transmission type spatial light modulator SLM, which is a light generation section disposed on an optical axis of a coherent beam emitted from a light source, and generates a signal beam SB and reference beam RB, and an objective lens module OBM which is a light interference section for allowing the signal beam SB and reference beam RB condense on the focal points on the optical axis which are different from each other, so as to allow the signal beam SB and reference beam RB to interfere. The spatial light modulator SLM is disposed at a position of one focal point distance of an objective lens OB of an objective lens module OBM, and a hologram recording layer 7 of a recording medium is positioned at the other focal point, and a reflection layer 5 is positioned at a position of the other focal distance of the objective lens OB. In FIG. 5f is the focal distance of the objective lens OB.

The spatial light modulator SLM has a signal beam region SBR and reference beam region RBR which are in a rotary inversion around the optical axis in a cross-section of the coherent beam, so as to spatially split the incident coherent beam into a signal beam SB and reference beam RB which transmit and propagate through the regions respectively. FIG. 6 shows a front view of the spatial light modulator SLM having a signal beam region SBR and reference beam region RBR.

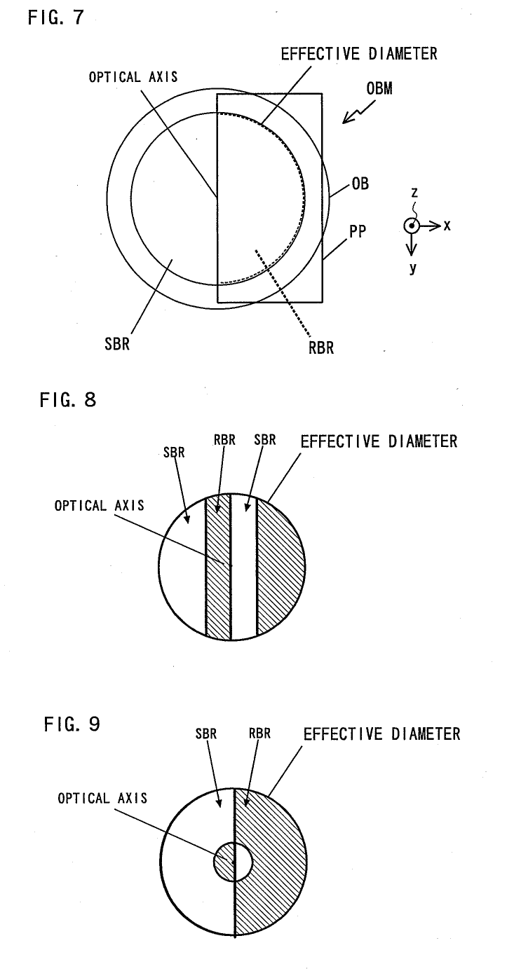

As FIG. 5 shows, an objective lens module OBM of the light interference section is comprised of an objective lens OB, which is a condensing lens disposed on the same axis as the spatial light modulator SLM, and a transmission type optical element, such as a transparent plane parallel plate PP. The objective lens module OBM as well has a signal beam region SBR and a reference beam region RBR, which are in a rotary inversion around the optical axis, which match these regions of the spatial light modulator SLM. FIG. 7 shows a front view of the objective lens module OBM having the signal beam region SBR and the reference beam region RBR along the optical axis.

As FIG. 6 shows, the spatial light modulator SLM of the light generation section modulates the coherent beam in the signal beam region SBR according to the information to be recorded, and generates the signal beam SB. The spatial light modulator SLM has a function to electrically shield a part of the incident light for each pixel using a liquid crystal panel having a plurality of pixel transparent electrodes, which are separated in a matrix, or a function to transmit the incident light in a non-modulation state. The spatial light modulator SLM modulates and transmits the beam, so as to have distribution based on page data (information pattern of two-dimensional data, such as contrast dot pattern on a plane) to be recorded which is sent from a control circuit 26, and a signal beam SB is generated. The reference beam region RBR of the spatial light modulator SLM generates the reference beam RB by transmitting the coherent beam without modulation. Therefore on the spatial light modulator SLM, information is displayed only on an area corresponding to the signal beam region SBR, and an area corresponding to the reference beam region RBR becomes the transmission. As FIG. 6 shows, only a part of the signal beam region SBR may be displayed as actual information. The spatial light modulator SLM can be constructed to perform control so that liquid crystal elements are in a state of displaying the signal beam region SBR and reference beam region RBR at recording, but the spatial light modulator SLM may have the reference beam region RBR constructed by a fixed through hole or transparent window.

This embodiment shows an example of the spatial light modulator SLM and the objective lens module OBM which are divided into the left and right, as the signal beam region SBR and the reference beam region RBR, which are in a rotary inversion respectively, but any division is acceptable only if the signal beam region and the reference beam region are in a rotary inversion with respect to the optical axis. The definition of the signal beam region SBR and the reference beam region RBR being in a rotary inversion is that the signal beam region SBR and the reference beam region RBR are replaced in an equivalent distribution when the respective regions are rotated 180 degrees around the optical axis. This also means that all beams which entered the signal beam region SBR on the objective lens OB pass through the reference beam region RBR on the objective lens OB and return (or vice verse). In all the examples shown in the following drawings, the signal beam region and the reference beam region are in a rotary inversion. In other words, the signal beam region SBR and the reference beam region RBR are formed with a relationship that these regions coincide with each other after a circular movement with respect to the optical axis of the optical path having an effective diameter of the coherent beam (i.e., the region patterns are overlapped as counterparts if they are rotated, e.g., 180 degrees around the optical axis). Namely, in symmetry operation, a strict rotary inversion means that if performing the rotation operation to rotate the signal beam region SBR and the reference beam region RBR by π/(2m−1) around the optical axis of the reference beam RB, then the signal beam region coincides with the reference beam region, and the reference beam region overlaps and matches the signal beam region. Here “m” is an integer, such as 1, 2, 3, 4, 5 and 6. As the “m” of rotary inversion becomes greater, the shield pattern becomes finer, and a greater influence of the diffraction effect is generated at the boundary between the shield region and the reference beam region, so about a maximum m=6 is preferable.

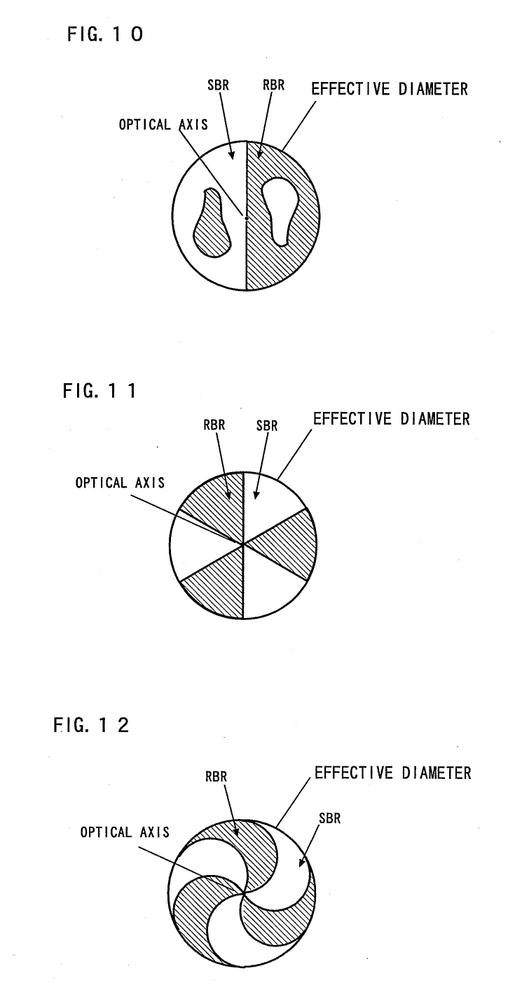

FIG. 8 to FIG. 10 are front views depicting a spatial light modulator SLM or objective lens module OBM which show examples of the signal beam region SBR and reference beam region RBR with m=1 of rotary inversion.

FIG. 11 and FIG. 12 are front views depicting a spatial light modulator SLM or objective lens module OBM which show examples of the signal beam region SBR and reference beam region RBR with m=2 of rotary inversion.

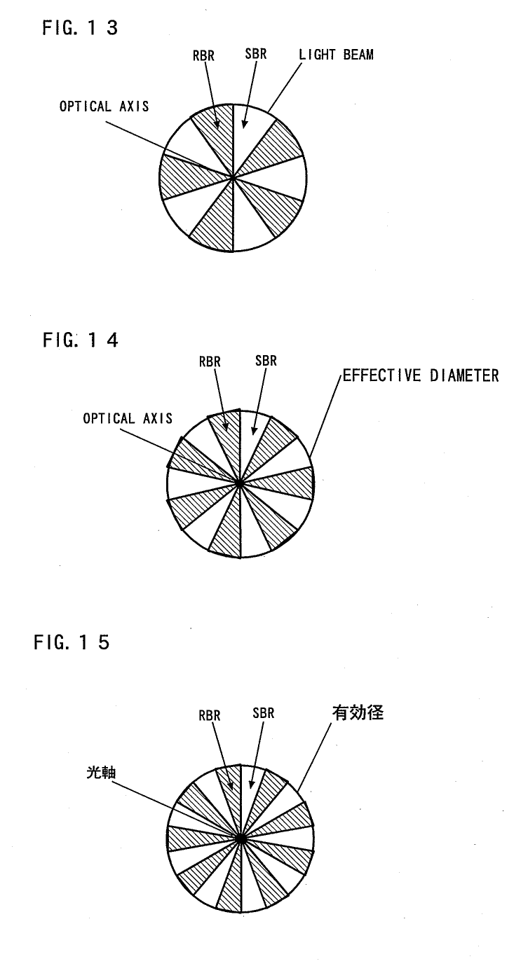

FIG. 13 is a front view depicting a spatial light modulator SLM or objective lens module OBM which show examples of the signal beam region SBR and reference beam region RBR with m=3 of rotary inversion.

FIG. 14 is a front view depicting a spatial light modulator SLM or objective lens module OBM which show examples of the signal beam region SBR and reference beam region RBR with m=4 of rotary inversion.

FIG. 15 is a front view depicting a spatial light modulator SLM or objective lens module OBM which show examples of the signal beam region SBR and reference beam region RBR with m=5 of rotary inversion.

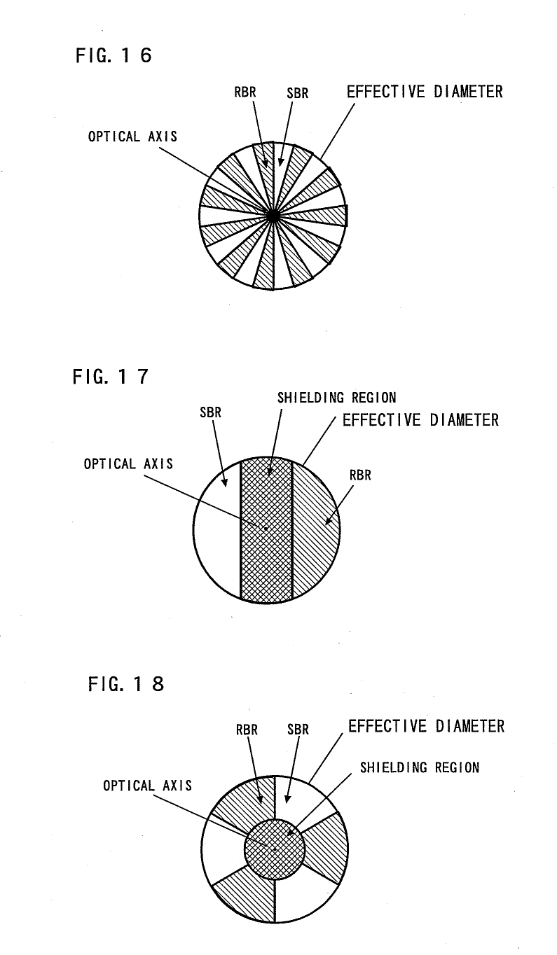

FIG. 16 is a front view depicting a spatial light modulator SLM or objective lens module OBM which show examples of the signal beam region SBR and reference beam region RBR with m=6 of rotary inversion.

As FIG. 17 and FIG. 18 show, apart of the effective diameter may be shielded in the signal beam region SBR and reference beam region RBR being in the rotary inversion. In this case, it is sufficient if the signal beam region and the reference beam region, other than the shielding region, are in the rotary inversion. The shield region is disposed on the objective lens OB, spatial light modulator SLM and optical paths there between, and shields light.

In this way, according to the present invention, the signal beam region SBR and reference beam region RBR being in a rotary inversion are disposed in an optical system around the optical axis, and the reference beam and signal beam are spatially split. At the same time, according to the present embodiment, the hologram is recorded by condensing the split reference beam and signal beam on focal points which are spatially different from each other on the optical axis, so as to interfere with each other.

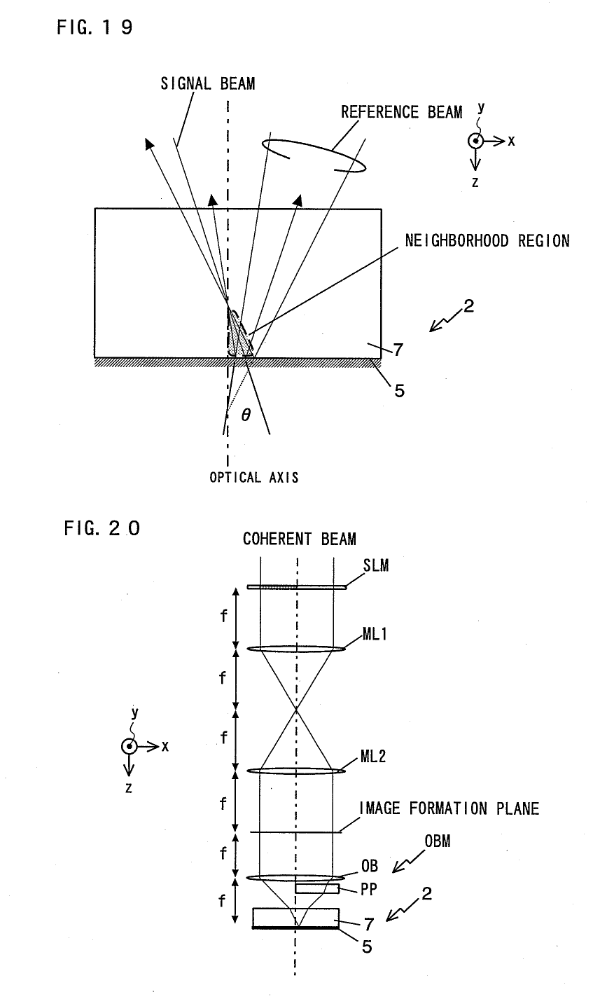

As FIG. 5 shows, the plane parallel plate PP is inserted only in a transmission region through which the reference beam RB transmits between the objective lens OB and the hologram recording layer 7 (reference beam region RBR), so the reference beam RB which passes through the objective lens OB and the plane parallel plate PP condenses at a position shifted from the condensing position of the signal beam SB, which passes through the region where only the objective lens OB exists (signal beam region SBR), in the optical axis direction. In the configuration example in FIG. 5, the objective lens module OBM is set so as to converge the signal beam SB at the front side and the reference beam RB at the back side respectively. By the interference fringes of the signal beam SB and the reference beam RB, the hologram (diffraction grating) is formed inside the hologram recording layer 7, mainly at the right side of the optical axis, as shown in FIG. 5. By shifting the focal positions of the signal beam SB and the reference beam RB, the signal beam SB and the reference beam RB cross at a mixing angle that is greater than 0 degrees in a neighborhood region near the optical axis and reflection layer 5 (region polarized to the optical axis), as shown in FIG. 19.

The beam which passes through the reference beam region RBR passes through the thickness of the hologram recording layer 7, and the thickness of the inserted plane parallel plate PP, while the beam passing through the signal beam region SBR, passes through only the thickness of the hologram recording layer 7 until reaching the reflection layer 5 at the opposite side of the hologram recording layer 7. Because of this, the optical length from the objective lens OB to the reflection layer 5 is different between the light transmitting through the signal beam region SBR and the light transmitting through the reference beam region RBR, so the condensing positions are also different. The beam reflected by the reflection layer 5 behaves the opposite of the incoming beam, and the beam which enters through the signal beam region SBR returns to the objective lens OB via the plane parallel plate PP. As a result, the optical path lengths of all beams which entered any portion of the objective lens OB becomes the same at the point when they reflect once and return to the objective lens OB. Therefore at an appropriate position on the reflection layer 5, the beam which entered the objective lens OB as a collimated light returns again as a collimated light from the objective lens OB. This means that the objective lens OB and the reflection layer 5 can be secured at a distance whereby the return light becomes collimated light, just like focus servo, which is performed on ordinary optical disks.

In this way, in the spatial light modulator SLM and the objective lens module OBM, the signal beam region SBR and the reference beam region RBR are in a rotary inversion with respect to the optical axis, and are disposed such that the signal beam region SBR substantially coincides with the reference beam region RBR if it is rotated 180 degrees around the optical axis. For example, even in the case when the right half is the signal beam region SBR and the left half is the reference beam region RBR, which is the opposite of the configuration example in FIG. 5, the signal beam region SBR and the reference beam region RBR in the spatial light modulator SLM and the objective lens module OBM are constructed to be in a rotary inversion with respect to the optical axis, and the signal beam SB may be converged at the back side and the reference beam RB may be converged at the front.

As shown in FIG. 5, it is unnecessary to actually dispose the spatial light modulator SLM at a position of focal distance f of the objective lens OB, and hologram recording, the same as FIG. 5, becomes possible if the spatial light modulator SLM is disposed such that the real image of the spatial light modulator SLM comes to the position of the focal distance f of the objective lens OB, using the image formation lenses ML1 and ML2, of which focal points match, as a so called “4f optical system”, shown in FIG. 20.

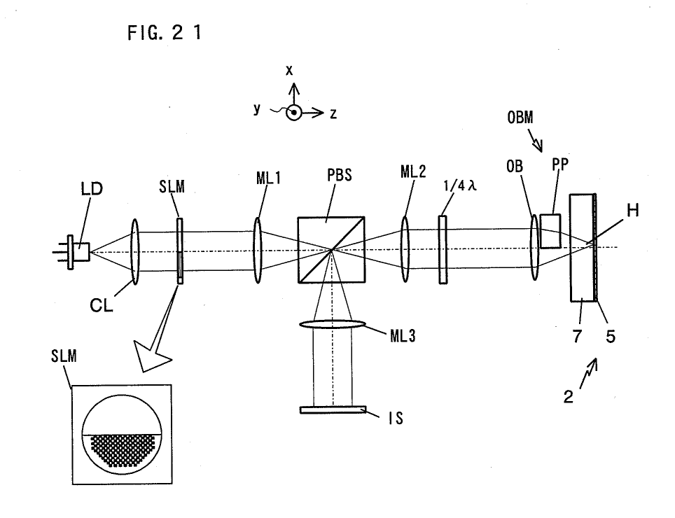

FIG. 21 shows a configuration example of the entire optical system of the hologram recording and reproducing device according to the present embodiment.

The hologram recording and reproducing device has a supporting section (not illustrated) for removably supporting a recording medium 2, having a hologram recording layer 7 which stores optical interference fringes formed by the coherent signal beam SB and reference beam RB inside as a diffraction grating, so that the reflection layer 5 positions at the opposite side of the light irradiation surface of the hologram recording layer 7. The hologram recording and reproducing device is mainly comprised of a hologram recording optical system and a hologram reproducing optical system, and these systems share an objective lens OB, and include an objective lens driving system and a servo error detection system (not illustrated). The hologram recording and reproducing optical system is comprised of a laser light source LD which generates coherent beams for recording and reproducing a hologram, a collimator lens CL, a transmission type spatial light modulator SLM, an image formation lens ML1, a polarizing beam splitter PBS, an image formation lens ML2, a quarter-wavelength plate ¼λ, an objective lens OB, a CCD (Charge Coupled Device), an image formation lens ML3, and an image sensor IS (this element is branched), for such an array of a CMOS (Complementary Metal Oxide Semiconductor) device, and is disposed on the optical path with the same axis.

The coherent beam emitted from the laser light source LD becomes a collimated light by the collimator lens CL, passes through the spatial light modulator SLM, image formation lens ML1, polarizing beam splitter PBS, image formation lens ML2, and quarter-wavelength plate ¼λ, and is irradiated onto the hologram recording layer 7 of the recording medium by the objective lens OB. The reflected beam from the hologram recording layer 7 and the reproduced beam of the hologram are guided to the image sensor IS by the polarizing beam splitter PBS via the image formation lens ML3. This configuration can be constructed in the same way as for an optical system of general optical disks.

When a hologram is recorded, as shown in FIG. 21, an information pattern is displayed on a signal beam region SBR of the spatial light modulator SLM, and a signal beam SB, which passes through the information pattern, and a reference beam RB, which passes through a reference beam region RBR where the information pattern does not exist, are generated. The information pattern on the spatial light modulation SLM forms an image on a position between the image formation lens ML2 and the objective lens OB by the function of the two image formation lenses, ML1 and ML2. By this image being irradiated on the hologram recording layer 7 of the recording medium by the objective lens OB, the signal beam SB and the reference beam RB interfere and generate a hologram in the hologram recording layer 7 of the recording medium.

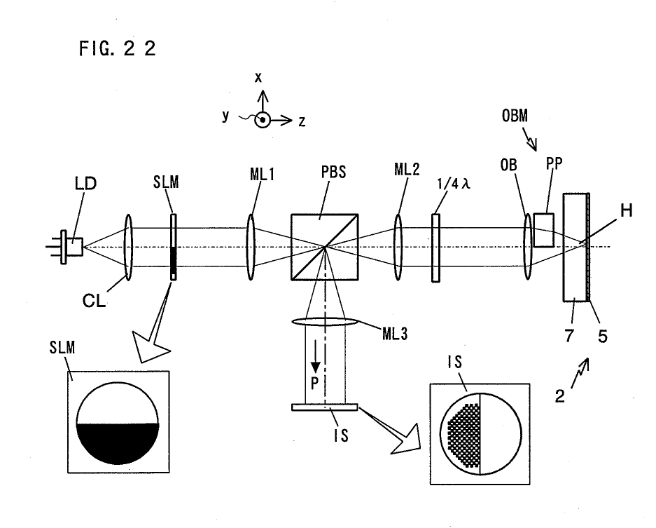

When the hologram is reproduced, as shown in FIG. 22, all the bits of the signal beam region SBR of the spatial light modulator SLM are set to 0 (opaque), and only the reference beam RB is irradiated from the reference beam region RBR to the hologram recording layer 7. By this, the reproducing beam (P) is reproduced from the hologram recorded in the hologram recording layer 7. If a linearly polarized reference beam RB is used, the reference beam RB, which is reflected by the hologram recording layer 7 and returns, transits through the quarter-wavelength plate ¼λ, twice, so the polarization direction is 90 degrees different from the incoming beam. Therefore the reproducing beam (P) is split from the irradiation optical system by the polarizing beam splitter PBS, and is directed to the image sensor IS via the image formation lens ML3. The reproducing light, which behaves the same as the reference beam RB regarding polarization, is also directed to the image sensor IS. The image sensor IS is disposed at a position where the reproducing image of the hologram is formed, and the pattern at recording is reproduced on the image sensor IS. On the image sensor IS, regions of the reproducing beam and the reference beam RB are separated, so only the reproducing beam can be extracted. In this way, the reproducing beam is generated from the diffraction grating by irradiating the reference beam, and the reproducing beam is guided to the image sensor IS via the objective lens OB, and the information is reproduced by photoelectric conversion.

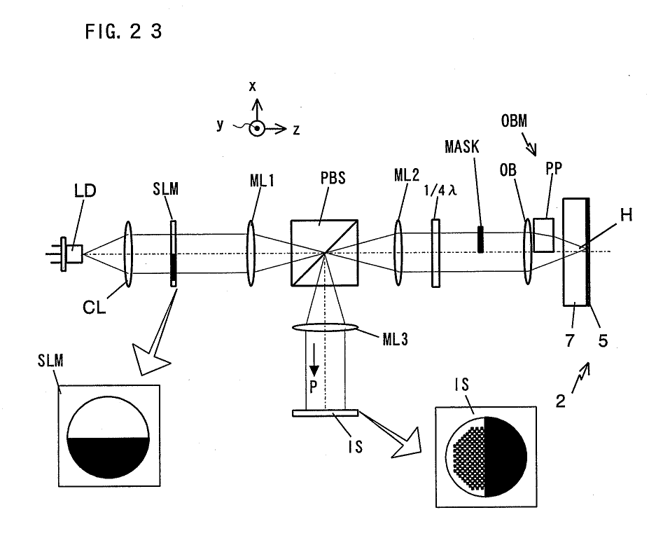

If the reference beam RB on this image sensor IS is not necessary, the reference beam may not return to the image sensor IS during reproducing by disposing the shielding plate MASK (which has a shielding section in a rotary inversion relationship with the reference beam region RBR with respect to the optical axis) between the image formation lens ML2 and the objective lens OB, as shown in FIG. 23.

In the configuration example in FIG. 5, the plane parallel plate PP is inserted as the reference beam region RBR, which transmits only the reference beam RB, but another embodiment described below is possible to polarize the condensing positions of the beams which pass through the reference beam region RBR and the signal beam region SBR on the optical axis. In other words, the focal positions of the reference beam and the signal beam may be shifted by changing the focal distance of the objective lens OB between the signal beam region SBR and the reference beam region RBR.

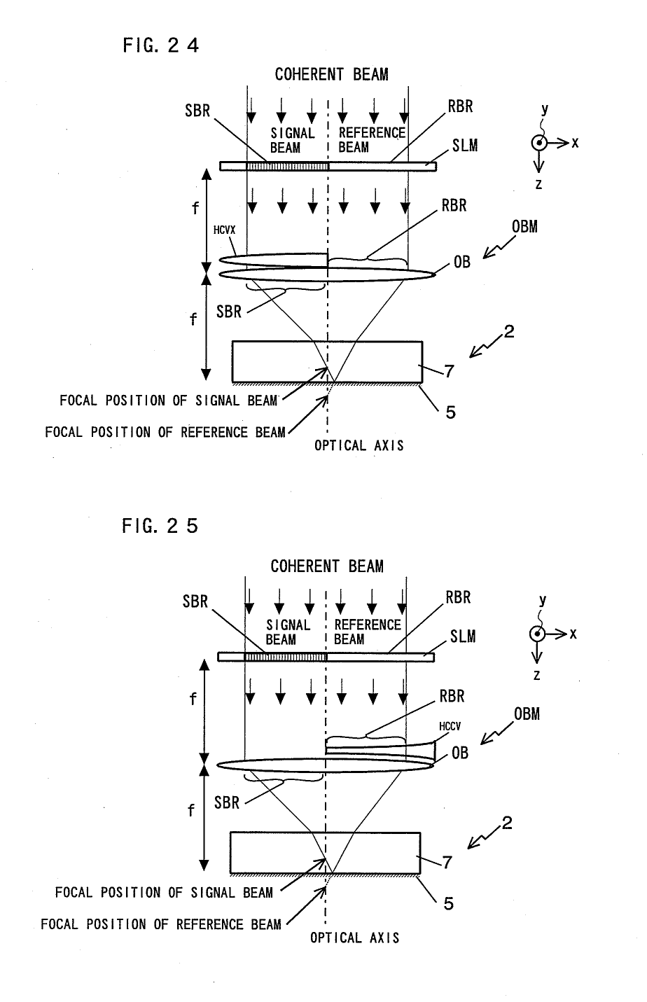

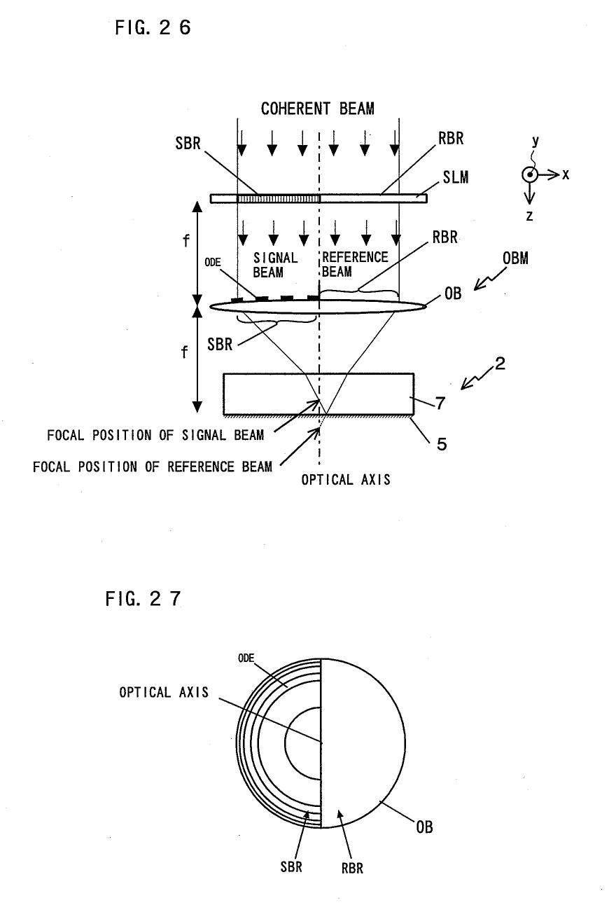

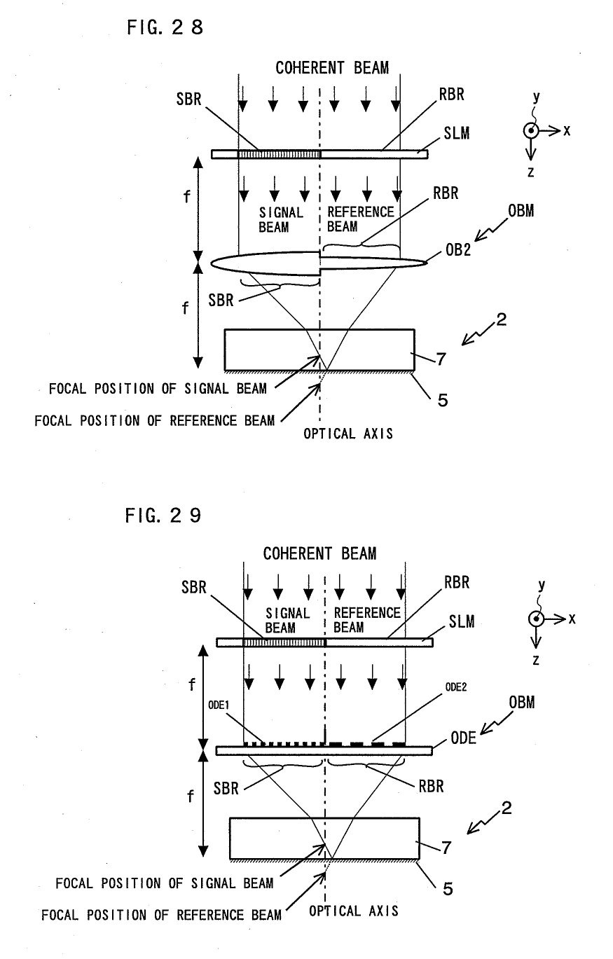

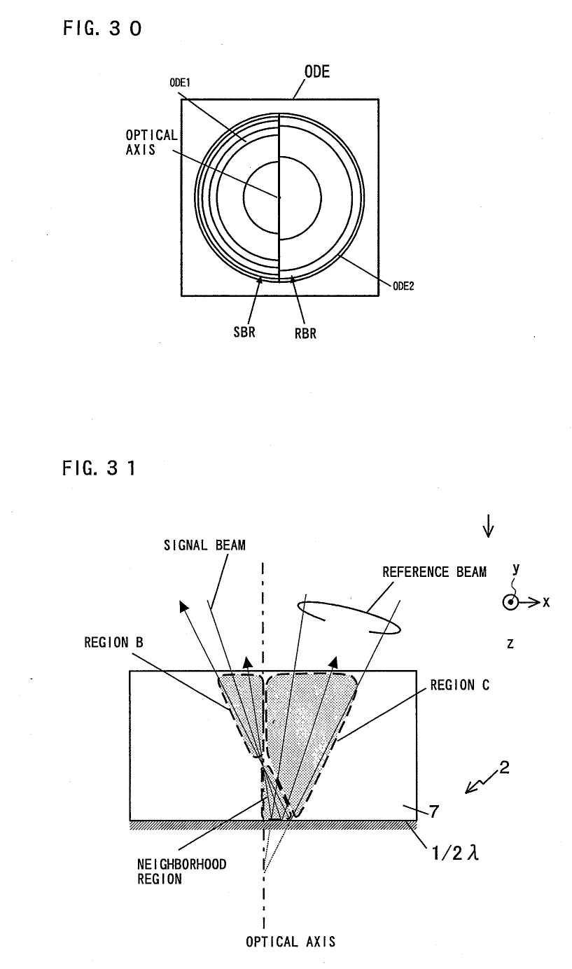

For example, in the case of an example of separating the signal beam region SBR and the reference beam region RBR as a rotary inversion, a similar effect can be acquired only by adding, as shown in FIG. 24, a half convex lens HCVX which is convex only at the left half (signal beam region SBR), or adding, as shown in FIG. 25, a half concave lens (HCCV) which is concave only at the right half (reference beam region RBR). These added lenses may be substituted with diffraction lenses. The diffraction lens ODE may be directly engraved into the signal beam region SBR (or reference beam region RBR) of the objective lens OB, as shown in FIG. 26. FIG. 27 shows an objective lens OB which has a diffraction lens ODE for decreasing the focal distance in the signal beam region SBR. Also as FIG. 28 shows, an objective lens OB2, where the focal distance is different between the signal beam region SBR and the reference beam region RBR respectively (the refractive power of the objective lens itself is different between the signal beam region SBR and the reference beam region RBR), may be used. Also as FIG. 29 shows, similar effects as the above embodiment can be exhibited by using a diffraction lens ODE comprised of diffraction lenses ODE1 and ODE2 having a lens function of the object lens, of which focal difference is different between the signal beam region SBR and the reference beam region RBR respectively (Fresnel lens, of which left and right sides have a different pitch). FIG. 30 shows a diffraction lens ODE having a diffraction lens ODE1, of which focal distance is short in the signal beam region SBR, and ODE 2, of which focal distance is long in the reference beam region RBR.

The optical system having a transmission type spatial light modulator has been described thus far, but a reflection type spatial light modulator may be used.

An embodiment where a reflection type half-wavelength plate ½λ is used for the reflection layer 5 positions opposite of the incoming side of the hologram recording layer 7, and the incident light is reflected as direct polarized light, can be proposed. In FIG. 4, it was described that the focal positions of the signal beam and the reference beam are shifted using the reflection layer 5, so as to increase the mixing angle, but in reality the reference beam and the signal beam cross at a portion other than the neighborhood region in FIG. 4, so a hologram is also recorded in this portion. In the case of the configuration in FIG. 4, the mixing angle is small also in a portion other than the neighborhood region, so angle selectability is poor. Although angle selectability is good in the neighborhood region, signals reproduced from a portion other than the neighborhood region, where angle selectability is poor, could generate noise if the multiple recording of a hologram is executed based on the angle selectability of the neighborhood region.

Therefore the configuration in FIG. 31, which is the same as the above embodiment, except that the reflection type half-wavelength plate ½λ is used instead of the reflection layer 5, is used. According to this, the polarization directions are 90 degrees different between the beam before being reflected by the reflection type half-wavelength plate ½λ and the beam after being reflected thereby, so the beam before reflection and the beam after reflection do not interfere with each other. Only the beams before reflection or the beams after reflection are interfere respectively. In region B shown in FIG. 31, only the signal beam before reflection and the reference beam after reflection exist, where interference does not occur. In region C, only the signal beam after reflection and the reference beam before reflection exist, where interference does not occur. In the neighborhood region, the interference of the reference beam and the signal beam before reflection, and the interference of the reference beam and the signal beam after reflection, occur, and here the hologram is recorded. If this configuration is used, the recording of a hologram with poor angle selectability can be avoided, and the recording region of the hologram can be limited to a small region. Even if a reflection layer is not formed on the recording medium, the hologram polarized from the optical axis can be recorded in the neighborhood region by the interference of an incoming reference beam and signal beam. In this case, regions B and C are not generated.

1. A hologram recording and reproducing system for recording information to or reproducing information from a recording medium which stores an optical interference pattern of a reference beam and a signal beam as a diffraction grating, the system comprising:
a light source for generating a coherent beam;
a light generation section which is disposed on an optical axis, has a signal beam region and a reference beam region that are in a rotary inversion with respect to the optical axis in a cross-section of said coherent beam, and spatially splits said coherent beam into a signal beam and a reference beam which propagate in said signal beam region and said reference beam region respectively;
a light interference section which is disposed on the optical axis, has a signal beam region and a reference beam region that are in a rotary inversion with respect to the optical axis, corresponding to said signal beam region and said reference beam region to transmit said reference beam and said signal beam respectively, and condenses said reference beam and said signal beam at different focal points on the optical axis so as to allow said reference beam and signal beam to interfere;
a recording medium comprising a hologram recording layer at least positioned between said different focal points;
image detection means which is disposed on the optical axis, and receives light returning from said hologram recording layer when said reference beam is irradiated on said hologram recording layer, via an objective lens optical system, and
wherein said recording medium has a reflection layer, and said hologram recording layer exists on a light source side of said reflection layer.

2. The hologram recording and reproducing system according to claim 1, wherein the signal beam region and the reference beam region in said light generation system and the signal beam region and the reference beam region in said light interference section coincide with each other.

3. The hologram recording and reproducing system according to claim 1, wherein the signal beam region and the reference beam region in said light generation section and the signal beam region and the reference beam region in said light interference section are in an image forming relationship respectively.

4. The hologram recording and reproducing system according to claim 1, wherein said light generation section comprises a spatial light modulator, and said spatial light modulator has a pattern where said signal beam region coincides with said reference beam region when a rotary operation of rotating said signal beam region and said reference beam region only by π/(2m−1) around said optical axis (m is a positive integer) is performed.

5. The hologram recording and reproducing system according to claim 4, wherein said m is 6 or less.

6. The hologram recording and reproducing system according to claim 1, wherein said light interference section comprises an object lens optical system, and said object lens optical system is a double focus lens which has a convex or concave lens, or a Fresnel lens surface having a convex or concave lens function, or a diffraction grating which is integrated with a condensing lens, and is formed on a refractive interface thereof so as to be equivalent to said signal beam region and reference beam region being in a rotary inversion.

7. The hologram recording and reproducing system according to claim 1, wherein said light interference section comprises an objective lens optical system, and said objective lens optical system is an objective lens module comprising a condensing lens, and a transmission type optical element which is disposed on a same axis as said condensing lens and has a convex or concave lens, or Fresnel lens surface having a convex or concave lens function, or diffraction grating, or plane parallel plate formed so as to be equivalent to said signal beam region and reference beam region being in a rotary inversion.

8. The hologram recording and reproducing system according to claim 4, wherein said spatial light modulator is in a state of displaying a pattern to modulate said coherent light beam according to the recorded information in said signal beam region, and is in a state of displaying a non-modulation pattern in said reference beam region.

9. (canceled)

10. The hologram recording and reproducing system according to claim 1, wherein said reflection layer exists between said different focal points.

11. The hologram recording and reproducing system according to claim 1, wherein said reflection layer is a reflection type half-wavelength plate.
